(19) United States
(12) Patent Application Publication
(10) Pub. No.: US 2018/0326653 A1
(43) Pub. Date: Nov. 15, 2018

(54) METHOD OF MANUFACTURING PRODUCT, METHOD OF MANUFACTURING OBJECT, AND BUILDING APPARATUS

(71) Applicant: MIMAKI ENGINEERING CO., LTD., Nagano (JP)

(72) Inventor: Yoshihiro Tanaka, Nagano (JP)

(73) Assignee: MIMAKI ENGINEERING CO., LTD., NAGANO (JP)

(21) Appl. No.: 15/960,568

(22) Filed: Apr. 24, 2018

(30) Foreign Application Priority Data
May 11, 2017 (JP) 2017-094705

(51) Int. Cl. B29C 64/112; B33Y 10/00; B33Y 70/00

(52) U.S. Cl. CPC B29C 64/112; B33Y 10/00; B29K 2995/003; B29K 2995/002; B33Y 70/00

(57) ABSTRACT

An object is created by a more appropriate method when the object is created by combining pieces. A method of manufacturing a product is provided, in which a product 50 for use as a piece is manufactured when a three-dimensional object 40 is created. The product 50 is built by adding layers of an ink. The product 50 includes a surface region 202, an end region 204, and an interior region 206. At least a part of the surface region 202 is formed in a colored state using a coloring ink. At least a part of the interior region 206 is formed as a light-reflective region using a light-reflective ink. At least a part of a portion along an edge portion 210 of the surface region 202 in the end region 204 is formed in a colored state using a coloring ink.

### CROSS REFERENCE TO RELATED APPLICATIONS

This application claims the priority benefit of Japanese Patent Application No. 2017-094705, filed on May 11, 2017. The entirety of the above-mentioned patent application is hereby incorporated by reference herein and made a part of this specification.

### TECHNICAL FIELD

The disclosure relates to a method of manufacturing a product, a method of manufacturing an object, and a building apparatus.

### BACKGROUND ART

Building apparatuses (3D printers) that build products using inkjet heads have been known (for example, see Japanese Unexamined Patent Application Publication No. 2015-71282). In such a building apparatus, for example, a product is built by additive manufacturing by adding a plurality of layers of ink formed by inkjet heads.

Patent Literature: Japanese Unexamined Patent Application Publication No. 2015-71282.

### SUMMARY

When a product is built by additive manufacturing using inkjet heads, building products to form a large object requires a large building apparatus. The large building apparatus, however, requires a large installation space and therefore has its limitations in the environment where it is installable. Moreover, the cost for the apparatus may be increased.

In this respect, the inventor of the subject application has contemplated dividing a large object into a plurality of pieces and building the pieces, rather than building a large object in its original form. In this case, for example, products serving as the pieces are built with a building apparatus and then combined to create an object. However, when examining an object created, the inventor has found that the boundary between pieces is visible and may affect the appearance of the object. It is therefore desired to create an object by a more appropriate method when the object is created by combining a plurality of pieces. The disclosure is then aimed to provide a method of manufacturing a product, a method of manufacturing an object, and a building apparatus.

The inventor of the subject application has conducted elaborate studies on a method of creating an object by combining a plurality of pieces, in which a product manufactured using an inkjet head is used as a piece. The inventor has found that the color in the interior of the object has a significant influence on the noticeability of the boundary portion between pieces. More specifically, when a colored product is built using an inkjet head, for example, a colored region is formed on the surface of the product using color ink as a coloring material. In this case, in order to reflect light incident from the outside of the product through the colored region, a light-reflective region is formed on the inside of the colored region, using a light-reflective material such as white ink.

In this case, for example, if an object is simply divided into a plurality of pieces, the light-reflective region is exposed at an end region of the piece that forms a cut surface serving as the boundary between pieces. As a result, the color of the light-reflective region may be visible through a slight gap between pieces in a state in which the object is assembled. As a result, the boundary portion between pieces may become noticeable and affect the appearance of the object.

In this respect, the inventor of the subject application has conducted even more elaborate studies and conceived of the idea of additionally coloring the end region of the piece, rather than simply dividing an object into a plurality of pieces. More specifically, the inventor has conceived of the idea that, in a product for use as a piece, at least a part of the end region is colored along the edge portion of a surface region that is the colored region of the portion serving as the surface of the object assembled. With such a configuration, for example, even when the interior of the object is visible through a gap between pieces, the effect of the color of the light-reflective region can be appropriately suppressed. Accordingly, for example, the noticeability of the boundary portion between pieces can be appropriately prevented.

The inventor has conducted even more elaborate studies and has found features necessary for obtaining such effects. This finding has led to completion of the disclosure. In order to solve the problem above, the disclosure provides a method of manufacturing a product, in which the product is manufactured for use as a piece when an object which is three-dimensional and assembled by combining a plurality of the pieces is created. The method includes building the product by adding a plurality of layers of an ink using an inkjet head configured to eject the ink as a building material. The product includes a surface region that partially forms a surface of the object in a state in which the object is assembled, an end region extending from an edge portion of the surface region to an interior of the object in a state in which the object is assembled and being an end portion on another one of the plurality of the pieces in the interior of the object in a state in which the object is assembled, and an inside region that is a portion other than the surface region and the end region and partially forms the interior of the object in a state in which the object is assembled. The method further includes: forming at least a part of the surface region in a colored state using a coloring ink; forming at least a part of the inside region as a light-reflective region using a light-reflective ink; and forming at least a part of a portion along the edge portion of the surface region in the end region, in a colored state using the coloring ink.

In such a configuration, for example, even when the interior of the object is visible through a gap between pieces in a state in which the object is assembled, the effect of the color of the light-reflective region can be appropriately suppressed. For example, the noticeability of the boundary portion between pieces thus can be appropriately prevented. With this configuration, for example, when an object is created by combining a plurality of pieces, the object can be created by a more appropriate method.

Here, in this configuration, the piece refers to, for example, a component that forms part of the object. The object is created, for example, by combining a plurality of products built as described above. The surface region is, for example, a region including a colored portion formed using a coloring material so as to conform to the surface shape of the object with a constant thickness. In this case, being formed with a constant thickness means, for example, being formed with a substantially constant thickness depending on the accuracy of building. Being formed with a substantially constant thickness means, for example, being formed with a thickness within a certain range, considering predetermined variations relative to a reference thickness.

In this configuration, the end region can be considered as, for example, a region forming the boundary with another piece. In this case, the region forming the boundary with another piece refers to a region including at least a part of the surface on the other piece in the product. In this case, whether the end region is in contact with the other piece is optional. In this case, forming the end region in a colored state means, for example, forming more portions in a colored state compared with when only the surface region is simply colored. More specifically, in this case, the end region may be formed, for example, such that the portion along the edge portion of the surface region is colored with at least a width larger than the thickness of the colored portion in the surface region. With such a configuration, for example, the end region can be colored more appropriately. The end region may be colored, for example, using the same coloring ink as the one used for coloring the surface region. Alternatively, the end region may be colored using coloring ink (for example, ink such as special color ink) different from the one used for coloring the surface region.

At least part of the end region may be formed, for example, so as to be orthogonal to, for example, the surface of the object. In this case, being orthogonal to the surface of the object means, for example, being orthogonal to the surface region at the edge portion of the surface region. In this case, it is preferable that, of the portion orthogonal to the surface region in the surface of the end region, at least a portion along the edge portion of the surface region is formed in a colored state. With such a configuration, for example, the noticeability of the boundary portion between pieces can be prevented more appropriately.

At least part of the end region may be formed, for example, so as to cross diagonally to the surface of the object. In this case, crossing diagonally means, for example, crossing at an angle other than the right angle. Crossing diagonally to the surface of the object means, for example, crossing diagonally to the surface region at the edge portion of the surface region. When the end region crosses diagonally to the surface region, the surface of the end region may face the outside of the object or may face the inside of the object, depending on the angle of crossing. In this case, it is preferable that, of the surface of the end region, the portion along the edge portion of the surface region in the surface facing the outside of the object is formed in a colored state. With such a configuration, for example, the noticeability of the boundary portion between pieces can be prevented more appropriately.

In this configuration, white ink may be used as the light-reflective ink. In this case, in at least a part of the portion along the edge portion of the surface region in the end region, the outside of the region formed with white ink may be formed to be colored. It is preferable that at least a part of the portion along the edge portion in the end region is colored, for example, to match the color of the surface region. In this case, coloring to match the color of the surface region means, for example, coloring in the same color or similar color as the color in the neighborhood of the edge portion in the surface region. In this case, the end region may be colored such that the color in the neighborhood of the edge portion in the surface region extends beyond the edge portion further to the inside of the end region. More specifically, in this case, at least a part of the portion along the edge portion of the surface region in the end region may be colored such that the color in the neighborhood of the edge portion in the colored region extends beyond the edge portion and connects into the end region. With such a configuration, the end region can be appropriately colored with a more natural impression.

In a state in which the object is assembled, the end region is usually hidden in the inside of the object. In this case, the color of the end region may have an impression darker or deeper than the color of the surface region colored under the same condition. For this reason, the end region may be colored with a color lighter than the color of the surface region, considering such an impression of the appearance. More specifically, in this case, at least a part of the portion along the edge portion of the surface region in the end region may be colored in the same coloration as the color in the neighborhood of the edge portion in the colored region and with a color lighter than the color in the neighborhood. With such a configuration, for example, the end region can be colored more appropriately to match the color of the surface region. At least part of the portion along the edge portion in the end region is not necessarily colored to match the color of the surface region but may be colored with a color selected independently of the color of the surface region. Also in such a case, for example, compared with when the color of the light-reflective region, such as white, is seen as it is, the noticeability of the boundary portion between pieces can be appropriately prevented. In this case, the end region may be colored, for example, with a color that looks darker when a gap between pieces is seen from the surface side of the object.

It is preferable that the product for use as a piece of the object is built in a configuration more suitable for the purpose of the piece. More specifically, in this case, a product labeled with identification information for use in identification of the piece forming the object may be built. In this case, the identification information may be formed, for example, so as to represent characters or numerals using coloring ink, for example, at the end region or on the surface of the inside region. For example, protrusions and depressions may be formed at the end region or on the surface of the inside region to represent the identification information by shapes.

The product for use as a piece of the object may be built, for example, in a shape having a handling portion which is a section used in handling. In this case, a handle, a hole, or the like may be formed as the handling portion. With such a configuration, for example, each piece can be easily handled during assembly of the object. The product for use as a piece of the object may be built in a shape having an engagement portion engaged with another piece in a state in which the object is assembled. In this case, the engagement portion may be formed, for example, in the shape of a hook engaged with an engagement portion of another piece. With such a configuration, for example, the object can be assembled more easily and appropriately.

In other aspects of the disclosure, a method of manufacturing an object and a building apparatus having similar features as described above may be provided. Also in this case, for example, similar effects as described above can be obtained.

According to the disclosure, an object can be created by a more appropriate method, for example, when the object is created by combining a plurality of pieces.

### BRIEF DESCRIPTION OF THE DRAWINGS

FIGS. 1A to 1C are diagrams illustrating an exemplary building apparatus 10 configured to perform a method of manufacturing a product according to an embodiment of the disclosure, in which FIG. 1A illustrates an exemplary configuration of the main part of the building apparatus 10, FIG. 1B illustrates an exemplary configuration of a head 12 in the building apparatus 10, and FIG. 1C is a diagram illustrating products 50 built by the building apparatus 10;

FIGS. 2A to 2C are diagrams illustrating a more detailed configuration of an object 40 and products 50, in which FIG. 2A is a cross-sectional view of the object 40 and the products 50 in a state in which the object 40 is assembled, FIG. 2B is a cross-sectional view of the object 40 or the product 50 taken along dashed and single-dotted lines AA and BB in FIG. 2A, and FIG. 2C illustrates an exemplary relation between the portions and the regions of the products 50;

FIGS. 3A to 3C are diagrams illustrating examples of the manner of coloring an end region 204, in which FIGS. 3A to 3C illustrate various examples of the manner of coloring the end region 204;

FIGS. 4A and 4B are diagrams illustrating modifications of the configuration of products 50, in which FIG. 4A illustrates a modification of the shape of the end region 204, and FIG. 4B illustrates a further modification of the configuration of the product 50;

FIGS. 5A and 5B are diagrams illustrating examples of the more specific configuration of an object 40 and products 50, in which FIG. 5A illustrates an exemplary configuration of the object 40 and the products 50 when the products 50 are built with the end region 204 not colored, and FIG. 5B illustrates an exemplary configuration of the object 40 and the products 50 when the products 50 are built with the end region 204 colored; and

FIGS. 6A to 6C are diagrams illustrating examples of the shape of the end region 204 of a product 50, in which FIGS. 6A to 6C illustrate various examples of the shape of the end region 204.

### DESCRIPTION OF EMBODIMENTS

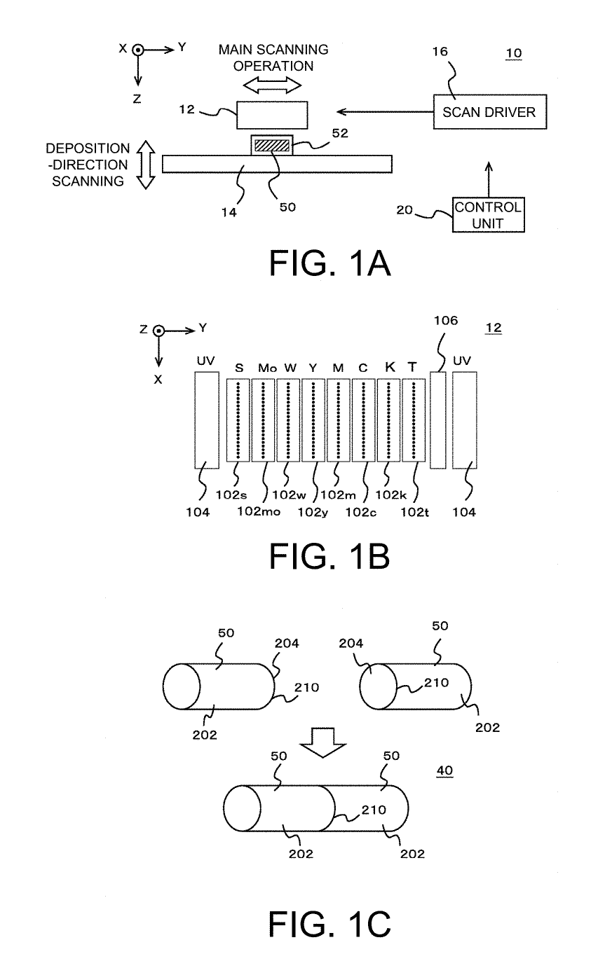

Embodiments according to the disclosure will be described below with reference to the figures. FIGS. 1A to 1C illustrate an exemplary building apparatus 10 configured to perform a method of manufacturing a product according to an embodiment of the disclosure. FIG. 1A illustrates an exemplary configuration of the main part of the building apparatus 10. FIG. 1B illustrates an exemplary configuration of a head 12 in the building apparatus 10.

The building apparatus 10 may have the same or similar features as well-known building apparatuses, except for the points described below. More specifically, for example, the building apparatus 10 may have the same or similar features as a well-known building apparatus that builds a product by ejecting droplets as the material of a product 50 using inkjet heads, except for the points described below. The building apparatus 10 may further include, for example, a variety of components necessary for building or coloring a product 50, in addition to the components illustrated in the figure.

In the present example, the building apparatus 10 is a building apparatus (3D printer) that builds a three-dimensional product 50 by additive manufacturing. In this case, additive manufacturing refers to, for example, a process of building a product 50 by adding layers one after another. The product 50 refers to, for example, a three-dimensional structure. The building apparatus 10 builds a product 50 for use as a piece when an object which is three-dimensional and assembled by combining a plurality of pieces is created. The relation between a product 50 used as a piece and an object will be described in more detail later with reference to, for example, FIG. 1C.

In the present example, the building apparatus 10 includes the head 12, a stage 14, a scan driver 16, and a controller 20. The head 12 is a unit ejecting the material of the product 50. In the present example, ink is used as the material of a product 50. In this case, ink refers to, for example, liquid ejected from the inkjet head. The inkjet head refers to, for example, an ejection head ejecting droplets of ink in an inkjet process. More specifically, the head 12 ejects, from a plurality of inkjet heads, ink that hardens depending on a predetermined condition as the material of a product 50. The landed droplets of ink are then cured to form layers, which are added to construct a product 50. In the present example, ultraviolet (UV) curable ink (UV ink) that hardens from a liquid state by ultraviolet radiation is used as ink.

The head 12 further ejects the material of a support layer 52, in addition to the material of the product 50. The head 12 thus forms the support layer 52, as necessary, on the periphery of the product 50. The support layer 52 refers to, for example, a deposited structure that surrounds the outer periphery of a product 50 being built to support the product 50. The support layer 52 is formed as necessary during building of a product 50 and removed after the building is finished.

The stage 14 is a table-shaped member for supporting a product 50 being built and is disposed at a position opposed to the inkjet heads in the head 12. The product 50 being built is placed on the upper surface of the stage 14. In the present example, the stage 14 is configured such that at least its upper surface is movable in the deposition direction (the Z direction in the figure). The stage 14 is driven by the scan driver 16 so that at least its upper surface is moved as the building of a product 50 proceeds. In this case, the deposition direction refers to, for example, a direction in which the building material is deposited in additive manufacturing. More specifically, in the present example, the deposition direction is a direction orthogonal to the main scanning direction (the Y direction in the figure) and the sub scanning direction (the X direction in the figure).

The scan driver 16 is a driver that allows the head 12 to perform a scanning operation of moving relative to the product 50 being built. In this case, moving relative to the product 50 being built means, for example, moving relative to the stage 14. Allowing the head 12 to perform a scanning operation means, for example, allowing the inkjet heads of the head 12 to perform a scanning operation. In the present example, the scan driver 16 allows the head 12 to perform a main scanning operation (Y scan), a sub scanning operation (X scan), and a deposition-direction scanning (Z scan).

The main scanning operation is, for example, the operation of ejecting ink while moving in the main scanning direction relative to the product 50 being built. In the present example, the scan driver 16 allows the head 12 to perform a main scanning operation by moving the head 12 while fixing the position of the stage 14 in the main scanning direction. The scan driver 16 may move the product 50, for example, by moving the stage 14, for example, while fixing the position of the head 12 in the main scanning direction.

The sub scanning operation is, for example, the operation of moving relative to the product 50 being built in the sub scanning direction orthogonal to the main scanning direction. More specifically, the sub scanning operation is, for example, the operation of moving relative to the stage 14 in the sub scanning direction by a preset feed amount. In the present example, the scan driver 16 allows the head 12 to perform the sub scanning operation by moving the stage 14 while fixing the position of the head 12 in the sub scanning direction, in the interval between the main scanning operations. Alternatively, the scan driver 16 may allow the head 12 to perform the sub scanning operation by moving the head 12 while fixing the position of the stage 14 in the sub scanning direction.

The deposition-direction scanning is, for example, the operation of moving the head 12 relative to the product 50 being built in the deposition direction. The scan driver 16 allows the head 12 to perform the deposition-direction scanning as the building operation proceeds, thereby adjusting the relative position of the inkjet heads to the product 50 being built in the deposition direction. More specifically, during the deposition-direction scanning in the present example, the scan driver 16 moves the stage 14 while fixing the position of the head 12 in the deposition direction. The scan driver 16 may move the head 12 while fixing the position of the stage 14 in the deposition direction.

The controller 20 is, for example, a central processing unit (CPU) of the building apparatus 10 and controls the building operation in the building apparatus 10 by controlling each unit in the building apparatus 10. More specifically, the controller 20 controls each unit in the building apparatus 10, for example, based on the shape information and the color information of the product 50 to be built. In the present example, the product 50 can be appropriately built.

A more specific configuration of the head 12 will now be described. In the present example, the head 12 has a plurality of inkjet heads, a plurality of UV light sources 104, and a planarizing roller 106. As illustrated in FIG. 1B, the inkjet heads include an inkjet head 102s, an inkjet head 102mo, an inkjet head 102w, an inkjet head 102y, an inkjet head 102m, an inkjet head 102c, an inkjet head 102k, and an inkjet head 102t.

These inkjet heads are disposed side by side in the main scanning direction, for example, so as to be aligned in the sub scanning direction. Each of the inkjet heads has a nozzle row including a plurality of nozzles arranged in a predetermined nozzle row direction, on a surface opposed to the stage 14. In the present example, the nozzle row direction is a direction parallel to the sub scanning direction.

Of these inkjet heads, the inkjet head 102s is an inkjet head ejecting the material of the support layer 52. For example, well-known materials for support layers can be suitably used as the material of the support layer 52. The inkjet head 102mo is an inkjet head ejecting a building material ink (Mo ink). In this case, the building material ink is, for example, ink dedicated for building and used for building the interior (interior region) of the product 50.

The interior of the product 50 may be formed using ink of another color, in addition to the building material ink. For example, the interior of the product 50 may be formed only with ink of another color (for example, white ink), without using the building material ink. In this case, the inkjet head 102mo in the head 12 may be omitted.

The inkjet head 102w is an inkjet head ejecting white (W) ink. In the present example, white ink is an example of light-reflective ink and is used for, for example, forming a region (light-reflective region) having the property of reflecting light in the product 50.

The inkjet head 102y, the inkjet head 102m, the inkjet head 102c, and the inkjet head 102k (hereinafter referred to as inkjet heads 102y to 102k) are inkjet heads for coloring to be used for building a colored product 50 and eject coloring ink of colors different from each other. More specifically, the inkjet head 102y ejects yellow (Y) ink. The inkjet head 102m ejects magenta (M) ink. The inkjet head 102c ejects cyan (C) ink. The inkjet head 102k ejects black (K) ink. In this case, the colors Y, M, C, and K are examples of process colors used for full-color representation by subtractive color mixing. The inkjet head 102t is an inkjet head ejecting clear ink. The clear ink refers to, for example, ink of a colorless transparent (T) clear ink.

The UV light sources 104 are light sources (UV light sources) for curing ink and generate ultraviolet rays for curing UV-curable ink. In the present example, the UV light sources 104 are disposed on one end side and the other end side in the main scanning direction in the head 12 such that the row of inkjet heads is sandwiched therebetween. For example, ultraviolet LEDs (UVLEDs) can be suitably used as the UV light sources 104. Alternatively, for example, metal halide lamps or mercury vapor lamps may be used as the UV light sources 104.

The planarizing roller 106 is planarizing means for planarizing the layer of ink formed during building of a product 50. The planarizing roller 106 comes into contact with the surface of a layer of ink, for example, during the main scanning operation and partially removes the ink before curing to planarize the layer of ink.

The head 12 having a configuration as described above can be used to appropriately form layers of ink that constitute the product SO. The product 50 can be appropriately built by adding a plurality of layers of ink.

The specific configuration of the head 12 is not limited to the configuration described above and may be modified in various ways. For example, the head 12 may further include an inkjet head for a color other than those described above, as an inkjet head for coloring. The arrangement of the inkjet heads in the head 12 may also be modified in various ways. For example, some of the inkjet heads may be displaced from other inkjet heads in the sub scanning direction.

The product 50 to be built using the building apparatus 10 will be described in more detail. FIG. 1C is a diagram illustrating products 50 built by the building apparatus 10. As described above, in the present example, the building apparatus 10 builds a product 50 for use as a piece when an object 40 which is three-dimensional and assembled by combining a plurality of the pieces is created. FIG. 1C schematically illustrates the relation between the products 50 and the object 40 when the object 40 is created by combining two products 50 that are cylindrical pieces.

For convenience of illustration and explanation, FIG. 1C schematically illustrates an exemplary configuration in which the object 40 is created by combining only two products 50 each having a simple shape. The object 40 may be created, for example, by combining more pieces (products 50). A product 50 having a more complicated shape may be used as the product 50 for use as a piece. Products 50 having shapes different from each other may be used as the products 50. More specifically, in this case, a plurality of products 50 may have a shape obtained by dividing an object 40 of a desired shape.

When an object 40 is created by combining a plurality of products 50, for example, the building apparatus 10 individually builds the product 50 corresponding to each piece forming the object 40. In this case, for example, a plurality of products 50 may be simultaneously built, depending on the shape of the products 50. In building an object 40, a plurality of products 50 pre-built are combined to create the object 40. With this configuration, for example, an object 40 having a size or shape difficult to build as a single product 50 can be created more appropriately.

Here, when an object 40 is created by combining a plurality of pieces (products 50), each product 50 may be formed with separate regions, for example, as illustrated in the figure, including a surface region 202 and an end region 204. In this case, the surface region 202 is a region, for example, that partially forms the surface of the object 40 in a state in which the object 40 is assembled. The end region 204 is a region, for example, that is an end portion on the other piece (product 50) in the interior of the object 40 in a state in which the object 40 is assembled. The end region 204 may also be considered as, for example, a region that forms a boundary with another piece. In this case, the region that forms a boundary with another piece is, for example, a region including at least a portion of the surface on the other piece in the product 50. In the case of the configuration illustrated in the figure, the end region 204 is a region in contact with the other piece. In a modified configuration of the object 40 or the product 50, the end region 204 may be, for example, a region that is not in contact with the other piece. In this case, though not denoted by a reference sign in FIG. 1C, a region other than the surface region 202 and the end region 204 can be considered as an interior region, which is the other region.

In this case, the surface region 202 of each product 50 is formed, for example, in a colored state using coloring ink so as to represent the surface color of the object 40 at a position where the piece is attached. With such a configuration, each position in the surface of the object 40 can be appropriately colored.

In this case, each product 50 is attached to the object 40, for example, such that only the surface region 202 is exposed on the surface (outer surface) of the object 40. Therefore, the end region 204 of the product 50 can be considered as, for example, a region that extends from the edge portion 210 of the surface region 202 to the interior of the object 40 in a state in which the object 40 is assembled. In this case, the interior region other than the surface region 202 and the end region 204 can be considered as, for example, a region that partially forms the interior of the object 40 in a state in which the object 40 is assembled.

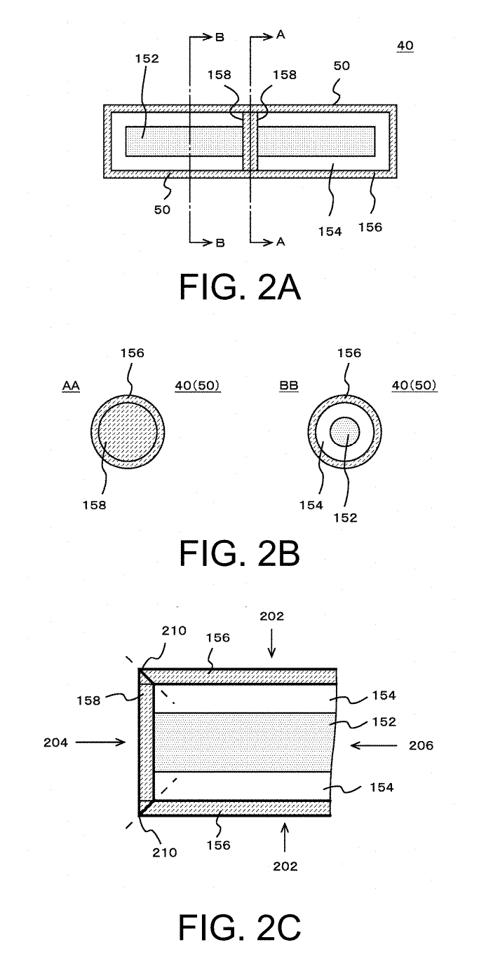

FIGS. 2A to 2C are diagrams illustrating a more detailed configuration of an object 40 and products 50 and illustrate an exemplary configuration of the interior of the object 40 and the products 50 illustrated in FIG. 1C. FIG. 2A is a cross-sectional view of the object 40 and the products 50 in a state in which the object 40 is assembled and illustrates an exemplary configuration of the cross-section of the object 40 and the products 50 taken at the position including a plurality of products 50. FIG. 2B is a cross-sectional view of the object 40 or the product 50 taken along the dashed and single-dotted lines AA and BB in FIG. 2A. FIG. 2C illustrates an exemplary relation between the portions and the regions of the product 50.

As illustrated in the figures, in the present example, each of the products 50 that constitute the object 40 includes an interior region 152, a light-reflective region 154, and a colored region (a colored region 156 and a colored region 158). In this configuration, the interior region 152 is a region that forms the interior of the product 50. The interior region 152 may be considered as, for example, a region that forms the shape of the product 50. In the present example, the building apparatus 10 forms the interior region 152 using building material ink ejected from the inkjet head 102mo (see FIGS. 1A to 10).

The light-reflective region 154 is a light-reflective region for reflecting light incident from the outside of the product 50 through the colored region. In the present example, the building apparatus 10 forms the light-reflective region 154 around the interior region 152 using white ink ejected from the inkjet head 102w (see FIGS. 1A to 1C).

The colored region (the colored region 156 and the colored region 158) is a region colored with coloring ink ejected from the inkjet heads 102y to 102k (see FIGS. 1A to 1C). In the present example, the building apparatus 10 forms a colored region using coloring ink ejected from the inkjet heads 102y to 102k and clear ink ejected from the inkjet head 102t (see FIGS. 1A to 1C). In this case, for example, various colors are represented by adjusting the amount of coloring ink of colors ejected to each position. Clear ink is used for compensating for variations in the amount of coloring ink (the amount of ejection per unit volume is 0% to 100%) due to the difference of color so that constant 100% is achieved. With such a configuration, for example, each position in the colored region can be appropriately colored in a desired color.

As illustrated in the figure, in the present example, the product 50 includes the colored region 156 and the colored region 158 formed as colored regions at positions different from each other. Of these regions, the colored region 156 is a colored region of which coloration can be visually recognized from the outside of the object 40 in a state in which the object 40 is assembled. The colored region 156 is colored with the surface color of the object 40. In this case, “the colored region 156 is colored with the surface color of the object 40” means, for example, that the colored region 156 is colored such that the surface color of the object 40 as designed is visually recognized from the outside of the object 40. In the product 50, the colored region 156 is formed on the outside of the light-reflective region 154. With such a configuration, for example, various colors can be appropriately represented by subtractive color mixing in the colored region 156.

In the present example, the colored region 156 can be considered as, for example, a colored portion formed using a coloring material so as to conform to the surface shape of the object with a constant thickness. In this case, being formed with a constant thickness means, for example, being formed with a substantially constant thickness depending on the accuracy of building. Being formed with a substantially constant thickness means, for example, being formed with a thickness within a certain preset range, considering predetermined variations relative to a reference thickness.

Of the colored regions of the product 50, the colored region 158 is a region colored in the end region 204 of the product 50. The colored region 158 can be considered as, for example, a colored region in the region of which color is unable to be visually recognized from the outside of the object 40 in a state in which the object 40 is assembled. In this case, being unable to be visually recognized from the outside of the object 40 means, for example, that the region is in the inside of the object 40 in an assembled state and its coloration is substantially unable to be recognized. “The coloration is substantially unable to be recognized” means, for example, the coloration is essentially unable to be recognized in design. Therefore, the effect of coloration of the colored region 158 of the actual object 40 may be recognized, for example, through a slight gap between adjacent products 50. In the present example, such a colored region 158 is formed so that the outside of the light-reflective region 154 formed with white ink is colored in at least a part of the portion along the edge portion 210 of the surface region 202 in the end region 204.

In the foregoing description, the regions that constitute the product 50 are separated, for example, in terms of the materials that form the regions. By contrast, in the present example, as described above in conjunction with FIGS. 1A to 1C, the regions that constitute the product 50 may be divided into a surface region 202, an end region 204, and an interior region 206, in terms of the use as a piece.

In this case, for example, as illustrated in FIG. 2C, of the colored regions of the product 50, the colored region 156 that is a portion of which coloration can be visually recognized from the outside of the object 40 is a region corresponding to the surface region 202. Of the colored regions of the product 50, the colored region 158 that is a portion serving as a boundary with another piece (product 50) in the object 40 is included in the end region 204. In the case of the configuration illustrated in FIG. 2C, for example, the interior region 152 and the light-reflective region 154 are regions corresponding to the interior region 206.

The surface region 202 is not necessarily exactly identical to the colored region 156 but, for example, may be considered as a region including the colored region 156. In the product 50, the colored region 156 and the colored region 158 are typically regions connected in a continuous manner, as illustrated in the figure. In actuality, when the product 50 is built, the colored region 156 and the colored region 158 may be formed such that they are not necessarily clearly distinguished from each other. Therefore, the boundary between the surface region 202 and the end region 204 is not necessarily strictly match the boundary between the colored region 156 and the colored region 158. In this case, for example, the surface region 202 and the end region 204 may be distinguished from each other such that the boundary between the products 50 on the surface of the object 40 is the edge portion 210 of the surface region 202. In this case, the region corresponding to the thickness of the colored region 156 or the colored region 158 may be, for example, allocated as appropriate to the surface region 202 or the end region 204, as denoted by a dashed line at the edge portion 210 of the surface region 202 in FIG. 2C.

When a product 50 having a configuration as described above is built, for example, the cross-sections of the interior region 152, the light-reflective region 154, and the colored region 156, which are the regions that constitute the product 50, appear in the cross-section of the object 40 taken at a position other than the end region 204, for example, at a position of the cross-section BB illustrated in FIG. 2B. Alternatively, a product 50 having a configuration simpler than that in the present example may be used as the product 50 for use as a piece of the object 40. In this case, for example, a product 50 having the configuration of a corresponding portion that is simply cut out from the object 40 may be used. Then, in this case, since the end region 204 of the product 50 is not to be colored as in the present example, the colored region 158 is not formed in the end region 204, and the interior region 152 and the light-reflective region 154 are exposed. As a result, the cross-section of the object 40 at the boundary between a plurality of products 50 (for example, the configuration of the cross-section at a position corresponding to the cross-section AA in the figure) is the same as the configuration of the cross-section BB.

In this case, for example, after the object 40 is assembled, the light-reflective region 154 that is likely to reflect light is present immediately on the inside of the edge portion 210 of the surface region 202 in the product 50 at the boundary between pieces that constitute the object 40. Therefore, for example, when a slight gap is produced between pieces, the interior of the gap is visible and, thus, the boundary portion between pieces may become noticeable.

By contrast, in the present example, since the colored region 158 is formed, the end region 204 of the product 50 is also formed in a colored state, for example, as illustrated in the cross-section AA in FIG. 2B. With such a configuration, for example, even when the interior of the object 40 is seen through the gap between pieces in a state in which the object 40 is assembled, the effect of the color of the light-reflective region 154 can be appropriately suppressed. For example, the noticeability of the boundary portion between pieces thus can be appropriately prevented. Therefore, according to the present example, for example, when an object 40 is created by combining a plurality of products 50, the object 40 can be created by a more appropriate method.

Here, we generalize the manner of forming the end region 204. For example, it is preferable that at least a part of the portion along the edge portion 210 of the surface region 202 in the end region 204 of the product 50 is formed in a colored state to match the color of the surface region 202 using coloring ink. In this case, being colored to match the color of the surface region 202 in the end region 204 means, for example, being colored in the same or similar color as in the neighborhood of the edge portion 210 in the surface region 202.

In the present example, the end region 204 is colored with the same coloring ink as that for coloring the surface region 202, using the inkjet heads 102y to 102k. In a modification of the manner of coloring the end region 204, for example, the end region 204 may be colored with coloring ink different from that for coloring the surface region 202, for example, with special color ink. Alternatively, the end region 204 may be colored, for example, in a color selected independently of the color of the surface region 202, rather than being colored to match the color of the surface region 202. Also in such a case, for example, the noticeability of the boundary portion between pieces can be appropriately prevented, compared with when the color (white) of the light-reflective region is exposed as it is. In this case, for example, the end region 204 may be colored in a color that looks darker than when the gap between pieces is visible from the surface side of the object 40.

In the present example, the end region 204 of the product 50 is formed so as to be orthogonal to the surface of the object 40. In this case, being orthogonal to the surface of the object 40 means, for example, being orthogonal to the surface region 202 at the edge portion 210 of the surface region 202. In this case, it is preferable that, of the portion orthogonal to the surface region 202 in the surface of the end region 204, at least the portion along the edge portion 210 of the surface region 202 is formed in a colored state to match the color of the surface region 202. With this configuration, for example, the noticeability of the boundary portion between pieces can be prevented more appropriately.

In the configuration described above, the product 50 mainly includes the interior region 152, the light-reflective region 154, and the colored region (the colored region 156 and the colored region 158). However, in a modification of the product 50, a specific configuration of the product 50 may be different from the one described above. More specifically, for example, the interior region 152 and the light-reflective region 154 are not distinguished from each other, and the interior region 152 also functioning as the light-reflective region 154 may be formed, for example, using white ink. Alternatively, part of the regions may be eliminated from the product 50. In this case, for example, the interior region 152 may be eliminated so that a product 50 having a cavity in the interior is built. An additional region other than those described above may be formed in the product 50. In this case, for example, an isolation region may be formed between the light-reflective region 154 and the colored region using clear ink. The isolation region refers to, for example, a transparent region (transparent layer) for preventing mixing of white ink forming the light-reflective region 154 and ink forming the colored region. For example, a transparent protective region may be formed using clear ink on the outermost region of the product 50 (for example, on the outside of the colored region 156).

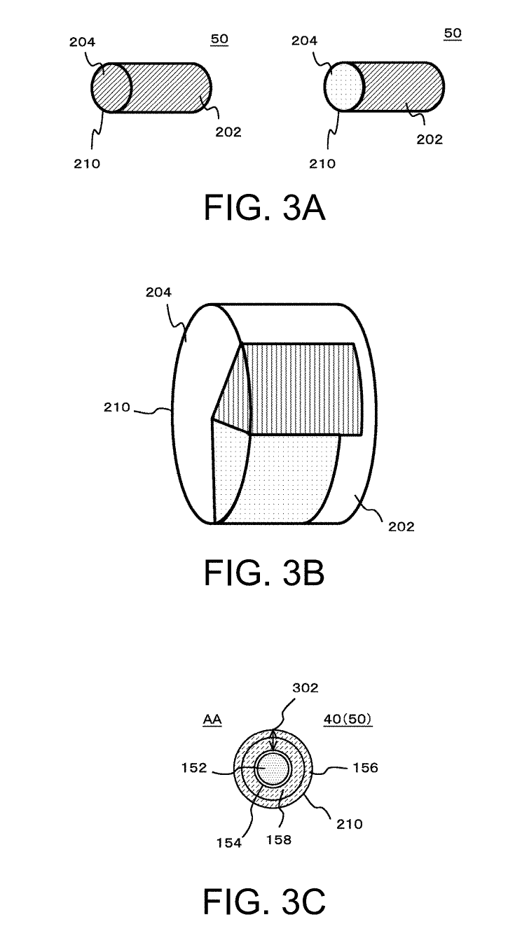

Various modifications of the manner of coloring the end region 204 will now be described. FIGS. 3A to 3C are diagrams illustrating examples of the manner of coloring the end region 204. FIGS. 3A to 3C illustrate various examples of the manner of coloring the end region 204. In FIGS. 3A to 3C, the components denoted by the same reference signs as in FIGS. 1A to 1C and FIGS. 2A to 2C may have the same or similar components as in FIGS. 1A to 1C and FIGS. 2A to 2C, except for the points described below.

As described above, it is preferable that at least the neighborhood of the edge portion 210 of the surface region 202 in the end region 204 is formed in a colored state to match the color of the surface region 202. In this case, more specifically, the end region 204 may be colored in the same color as the surface region 202. In this case, the same color means, for example, the color of the same coloration and brightness (depth of color). The same color as the surface region 202 means, for example, the same color as the neighborhood of the edge portion 210 in the surface region 202. In this case, for example, as can be seen in the product 50 schematically illustrated on the left side in FIG. 3A, the end region 204 may be colored exactly in the same way as the surface region 202.

In a state in which the object 40 is assembled, the end region 204 is usually hidden in the inside of the object 40. In this case, the color of the end region 204 may have an impression darker or deeper than the color of the surface region 202, for example, when the color is seen through a slight gap between pieces. Therefore, considering the such an impression of the appearance, the end region 204 may be colored in a lighter color than the color in the surface region 202, for example, as schematically illustrated on the right side in FIG. 3A. More specifically, in this case, at least a part of the portion along the edge portion 210 of the surface region 202 in the end region 204 may be colored in the same coloration as the neighborhood of the edge portion 210 in the surface region 202 and in a lighter color than the color in the neighborhood. With such a configuration, for example, the end region 204 can be colored more appropriately to match the color of the surface region 202.

In FIG. 3A and other figures, for convenience of illustration and explanation, the coloring of the surface region 202 and the end region 204 has been illustrated and described without considering the matters related to the difference in color within a region. However, the object 40 (see FIGS. 1A to 1C) may be colored, for example, such that colors vary with positions, by drawing patterns or graphics on the surface. In this case, the color is changed with positions in the surface region 202 of the product 50 for use as a piece.

In such a case, it is preferable that the end region 204 is also colored to match the color of each portion of the surface region 202, rather than being colored uniformly. In FIG. 3B, regions of different colors are represented by different hatch patterns to schematically illustrate an example of the state in which the surface region 202 is colored in a plurality of colors.

More specifically, the building apparatus 10 builds a product 50, for example, based on building data representing the product 50. For example, data representing the shape of the product 50 or the color of each position of the product 50 is used as the building data. In this case, during generation of building data, data may be corrected such that the end region 204 of the product 50 is also colored. In this correction processing, for example, building data may be corrected such that the color in the neighborhood of the edge portion 210 in the surface region 202 extends further to the end region 204 and thereby the end region 204 is colored to match the color of the surface region 202. With this configuration, for example, the end region 204 can be appropriately colored with a more natural impression. Such a manner of coloring can be considered as, for example, the operation of forming the end region 204 in a colored state to match the color of the surface region 202, by coloring at least a part of the portion along the edge portion 210 of the surface region 202 in the end region 204 such that the color in the neighborhood of the edge portion 210 in the surface region 202 extends beyond the edge portion 210 and connects into the end region 204.

In the foregoing description, the configuration in which the colored region is formed over the entire end region 204 has been described as an example of the configuration of the product 50 with reference to FIGS. 2A to 2C and other figures. However, in a modified configuration of the product 50, the colored region may be formed only in part of the end region 204. For example, FIG. 3C illustrates an example in which the colored region 158 is formed in only part of the end region 204. In this case, in the end region 204, the colored region 158 is formed along the edge portion 210 of the surface region 202. In the other portion, the light-reflective region 154 and the interior region 152 are exposed. “The colored region 158 is formed along the edge portion 210 of the surface region 202” means, for example, that the frame-like colored region 158 along the edge portion 210 is formed as illustrated in the figure. Also in such a configuration, for example, the portion that can be particularly easily seen through the gap between pieces in the end region 204 is colored so that, for example, the noticeability of the boundary portion between pieces is appropriately prevented.

Here, in this configuration in which only the portion along the edge portion 210 in the end region 204 is colored, forming the end region 204 in a colored state can be considered as, for example, forming the end region 204 in a state in which more portions are in a colored state compared with when only the colored region 156 corresponding to the surface region 202 of the product 50 is formed. With such a configuration, for example, the end region 204 can be appropriately colored.

The end region 204 in such a state can also be considered as, for example, a configuration in which the portion along the edge portion 210 of the surface region 202 is colored to match the color of the surface region 202, at least with a width larger than the thickness of the colored region 156 that is a colored portion in the surface region 202. In this case, the width of the region colored along the edge portion 210 in the end region 204 is a width in a direction along the surface of the end region 204 orthogonally to the edge portion 210 as denoted by the arrow 302 in the figure. More specifically, for example, when the thickness of the colored region 156 is D (for example, D=about 100 to 150 μm), the end region 204 may be formed such that the region along the edge portion 210 in the end region 204 is colored with a width larger than D. This width is preferably, for example, equal to or greater than D+50 μm. This width is preferably, for example, equal Lo or greater than 200 μm.

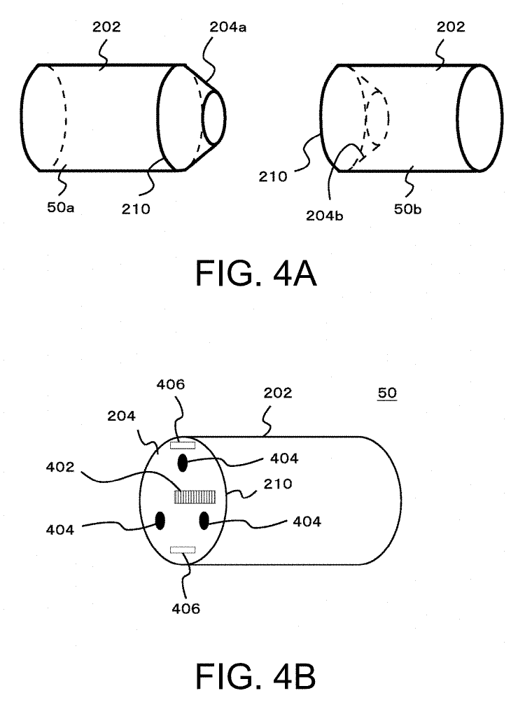

The configuration of the product 50 may be modified not only in terms of the manner of coloring the end region 204 but also in other respects. FIGS. 4A and 4B illustrate a modified configuration of the product 50. Except for the points described below, the components in FIGS. 4A and 4B denoted by the same reference signs as in FIGS. 1A to 1C to FIGS. 3A to 3C may have the same or similar features as the components in FIGS. 1A to 1C to FIGS. 3A to 3C.

The configuration in which the end region 204 of the product 50 is formed orthogonally to the surface of the object 40 (see FIGS. 1A to 1C) has mainly been described above, for convenience of explanation. However, the cut surface that divides the object 40 into a plurality of pieces is not necessarily orthogonal to the surface of the object 40, and the object 40 may be divided into a plurality of pieces through various cut surfaces. In this case, at least a part of the surface of the end region 204 of the product 50 for use as a piece may be formed so as to cross diagonally to the surface region 202 at the edge portion 210 of the surface region 202. In this case, “the end region 204 crosses diagonally to the surface region 202” means, for example, that the end region 204 crosses the surface region 202 at an angle other than the right angle. “The end region 204 crosses the surface region 202 at an angle other than the right angle” may mean, for example, that part of the end region 204 crosses the surface region 202 at an angle other than the right angle.

FIG. 4A is a diagram illustrating a modification of the shape of the end region 204 and schematically illustrates an exemplary configuration in which two products 50a and 50b corresponding to two pieces adjacent in a state in which the object 40 is assembled have respective end regions 204a and 204b crossing diagonally to the surface region 202. More specifically, in this case, the end region 204a of one product 50a has a diagonal surface protruding from the surface region 202 to the outside of the product 50a. On the other hand, the end region 204b of the other product 50b has a diagonal surface recessed from the surface region 202 to the inside of the product 50b. In this case, in a state in which the object 40 is assembled, the convex portion surrounded by the end region 204a in the product 50a is accommodated in the concave portion surrounded by the end region 204b in the product 50b. Also in this configuration, for example, an object 40 can be appropriately created by combining a plurality of products.

Also in this case, the end region of the product is formed in a colored state to match the color of the surface region 202, whereby the noticeability of the boundary portion between pieces can be prevented. When the end region having a diagonal surface is used as in the present modification, only the portion slanted in an orientation that can be easily seen through the gap between pieces may be colored. More specifically, in this case, for example, as can be understood from the comparison between the end region 204a and the end region 204b illustrated in the figure, the surface of the end region may face, for example, the outside of the object 40 as in the end region 204a or may face, for example, the inside as in the end region 204b, depending on the angle of crossing. In this case, it is preferable that, of the surface of the end region, at least the portion along the edge portion 210 of the surface region 202 in the surface facing the outside of the object 40 is formed in a colored state to match the color of the surface region 202.

More specifically, in the configuration illustrated in FIG. 4A, in the end region 204a of the product 50b, the surrounded portion is a convex portion and may be easily seen through the gap between pieces. Therefore, it is preferable that the end region 204a is colored to match the color of the surface region 202. By contrast, in the end region 204b of the product 50b, the surrounded portion is a concave portion and may be less likely to be seen through the gap between pieces. Therefore, for example, coloring the end region 204b may be omitted. With such a configuration, for example, the noticeability of the boundary portion between pieces can be prevented more appropriately.

The product 50 for use as a piece of the object 40 may be built, for example, in a configuration more suitable for the purpose of the piece. FIG. 4B illustrates a further modification of the configuration of the product 50. In the present modification, the product 50 further includes identification information 402, a handling portion 404, and an engagement portion 406 adapted to the purpose of the piece, in addition to the components described above.

The identification information 402 is information for use in identification of the piece included in the object 40. When the product 50 is built with such identification information 402, for example, the piece can be identified more easily and appropriately during building of the object 40. In this case, the identification information 402 may be formed so as to represent characters or numerals using coloring ink, for example, in the same manner as patterns or graphics drawn on the surface region 202. The identification information 402 may represent information by shapes, for example, by forming projections and depressions on the surface of the end region 204. Alternatively, the identification information 402 may represent information, for example, by various known methods, such as barcodes. For example, when the object 40 is assembled automatically using a device, information read from the identification information 402 may be used for assembly. For example, when the object 40 is assembled manually by a worker, the identification information 402 may be read using a terminal, such as a smartphone used by the worker. In this case, for example, the position of the piece corresponding to the product 50 in the object 40 may be displayed on a terminal such as a smartphone, based on the information read from the identification information 402.

The handling portion 404 facilitates the handling of the product 50 in the post-processing after building of the product 50 (for example, during assembly of the object 40) and functions as a section to be used during handling. More specifically, in the configuration illustrated in the figure, the handling portion 404 is a plurality of holes formed in the end region 204. In this case, for example, a jig for grasping the product 50 may be partially inserted in the holes of the handling portion 404 to handle the product 50. With such a configuration, for example, the product 50 can be handled more easily and appropriately.

In a further modified configuration of the product 50, the handling portion 404 may be, for example, a handle. Also in this case, for example, the product 50 can be handled more easily and appropriately. When the handling portion 404 protruding from the surface of the product 50, such as a handle, is formed, it is preferable that the handling portion 404 is formed so as to be removable when becoming unnecessary.

The engagement portion 406 is engaged with another piece in a state in which the object 40 is assembled. In the present example, the engagement portion 406 is formed together with the body of the product 50, using the building apparatus 10. Such an engagement portion 406 can be used to ensure connection of a plurality of pieces. More specifically, the engagement portion 406 may be shaped like, for example, a well-known hook or fastener. In this case, for example, the engagement portion 406 may be inserted in a hole formed in another piece (product 50) to fix the product 50 to the other piece. In this case, for example, a concave portion may be additionally formed in the hole of the other piece and engaged with the engagement portion 406, such as a hook, to produce a click. In this case, for example, the hole in the other piece can be considered as the engagement portion 406 in the product 50 forming the other piece. In this case, the engagement portion 406 may be engaged with, for example, the engagement portion in the other piece (product 50) to fix the product 50 to the other piece. With such a configuration, for example, the object 40 can be assembled more easily and appropriately.

In FIG. 4B, for convenience of illustration and explanation, the product 50 including all of the identification information 402, the handling portion 404, and the engagement portion 406 has been described. However, in a further modified configuration, the product 50 may include only part of them. In general, it is preferable that the identification information 402, the handling portion 404, and the engagement portion 406 are formed at a position where they are not noticeable after assembly of the object 40. For this reason, these components may be formed in the end region 204 as described above. Depending on the purpose and the configuration of the product 50, for example, these components may be formed in a region (for example, the surface region 202) other than the end region 204.

The configuration and further modifications of the object 40 and the product 50 will now be further elaborated. First, as a supplemental description on the configuration of the object 40 and the product 50, examples of the more specific configuration of the object 40 and the product 50 will be described.

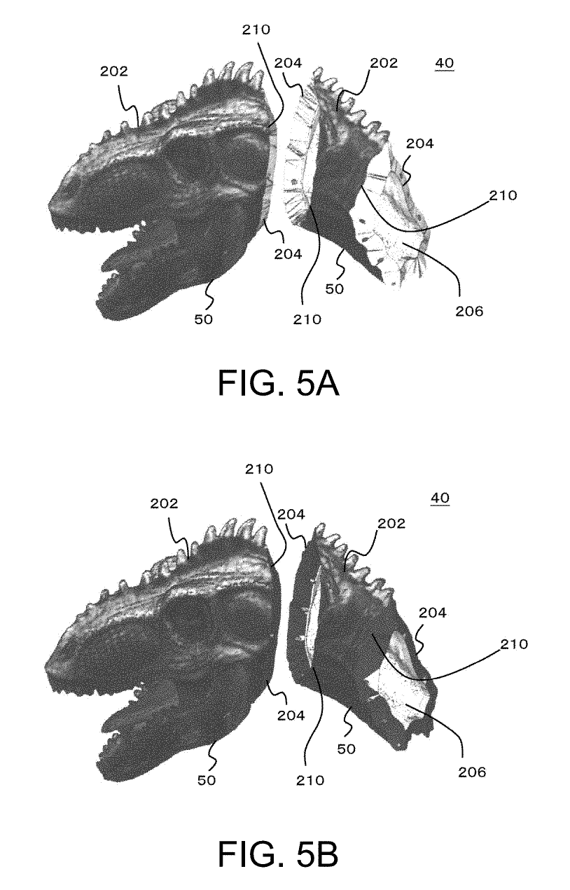

FIGS. 5A and 5B illustrate examples of the more specific configuration of the object 40 and the product 50. FIG. 5A illustrates an example of the configuration of an object 40 and products 50 in a case where the products 50 are built with the end region 204 not colored. FIG. 5B illustrates an example of the configuration of an object 40 and products 50 in a case where the products 50 are built with the end region 204 colored. In FIGS. 4A and 4B, the components denoted by the same reference signs as in FIGS. 1A to 1C to FIGS. 3A to 3C may have the same or similar features as the components in FIGS. 1A to 1C to FIGS. 3A to 3C, except for the points described below.

The object 40 illustrated in FIGS. 5A and 5B is an object representing a replica of a dinosaur. A plurality of products 50 are pieces that form part of this replica. In this manner, for example, a large object 40 can be appropriately created by dividing the object 40 into a plurality of pieces.

However, as illustrated in FIG. 5A, when the product 50 is built with the end region 204 not colored, the color of the end region 204 in a portion along the edge portion 210 of the surface region 202 is white, which is the color of the light-reflective region formed under the surface region 202 that is the colored region. In this case, for example, if the inside of the object 40 is visible through the gap between pieces in the object 40 (the gap between the products 50), the boundary portion between pieces may become noticeable due to the effect of this white portion, as described above.

By contrast, as illustrated in FIG. 5B, the product 50 is built with the end region 204 colored. In this case, even when the color of the end region 204 is visible through the gap between pieces, the boundary region between pieces is less noticeable, as described above. Therefore, as described above, in this example, the object 40 can be created by a more appropriate method, for example, when the object 40 is created by combining a plurality of products 50.

The shape of the end region 204 will now be further elaborated. As described above, the end region 204 may be shaped to be orthogonal to the surface region 202 or may be shaped to cross diagonally to the surface region 202. Alternatively, the surface of the end region 204 may be formed, for example, in the shape of a curve, protrusions and depressions, or a step, rather than being formed to be planar. For example, when the object 40 that is a replica as illustrated in FIGS. 5A and 5B is created, the interior thereof may be shaped like a cavity. In this case, the product 50 for use as a piece may partially form the surface portion (shell-like portion) that surrounds the cavity in the object 40. In this case, the end region 204 of the product 50 is the boundary portion between pieces in the surface portion of the object 40. Also in such a case, the end region 204 of the product 50 may have various shapes.

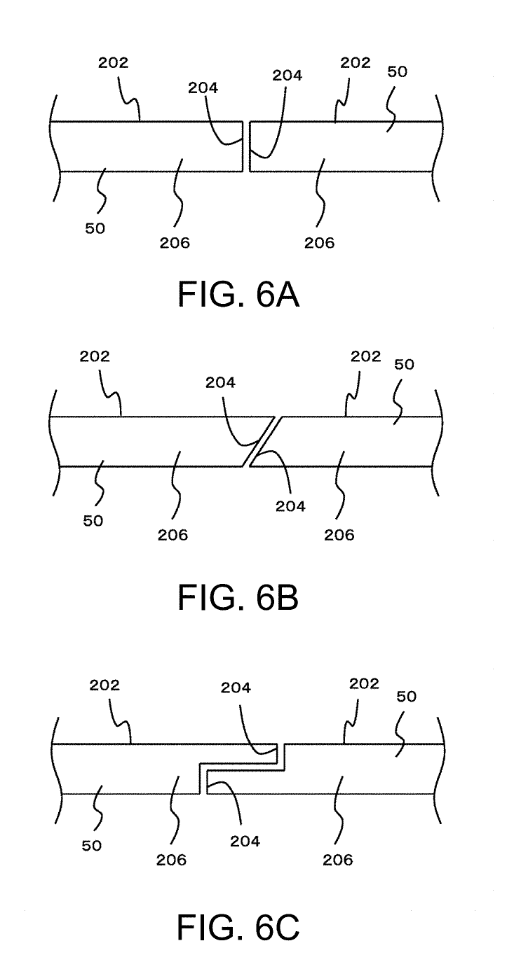

FIGS. 6A to 6C are diagrams illustrating examples of the shape of the end region 204 of the product 50 and schematically illustrate examples of the shape of the end region 204 in the product 50 for use as a piece of the object 40 having a cavity in the interior. In FIGS. 6A to 6C, the components denoted by the same reference signs as in FIGS. 1A to 1C to FIGS. 5A and 5B may have the same or similar features as the components in FIGS. 1A to 1C to FIGS. 5A and 5B, except for the points described below.

FIGS. 6A to 6C illustrate various examples of the shape of the end region 204. More specifically, FIG. 6A illustrates an example in which the end region 204 is shaped to be orthogonal to the surface region 202. FIG. 6B illustrates an example in which the end region 204 is shaped to cross diagonally to the surface region 202. FIG. 6C illustrates an example in which the end region 204 is shaped like a step. Also with such configurations, at least a part of the end region 204 is colored to appropriately prevent, for example, the noticeability of the boundary portion between pieces.

Modifications of the manner of creating the object 40 will now be described. In order to make the boundary portion between pieces less noticeable in the object 40, a variety of processing (post-processing) may be performed. In this case, such processing may include, for example, overcoating the combined pieces with a transparent material. In this case, it is preferable that at least a joint between pieces is overcoated. With such a configuration, for example, the boundary portion between pieces can be made less noticeable.

In this case, for example, well-known overcoat materials (for example, clear ink) may be used as the material for overcoating. In this case, the processing of overcoating is performed on a large object 40 after pieces are combined. Therefore, the material for overcoating may be applied, for example, using a spray or a brush, rather than using inkjet heads. Alternatively, for example, the material for overcoating may be applied by immersing the object 40 in the material for overcoating.

Other processing for making the boundary portion between pieces less noticeable may include, for example, melting the boundary portion between pieces to obscure the boundary. More specifically, in this case, for example, the boundary portion between pieces may be slightly melted by heat or a solvent. Also with such a configuration, for example, the boundary portion between pieces can be made less noticeable.

Other processing for making the boundary portion between pieces less noticeable may include, for example, polishing the boundary portion between pieces. More specifically, in this case, the boundary may be obscured by polishing using, for example, a sand blaster. In this case, it is preferable that the colored region is formed to be slightly thick, considering the amount removed by polishing. In this case, “the colored region is formed to be slightly thick” means that, for example, the thickness of the colored region is set larger than when the product 50 is built without polishing with a sand blaster. Also with such a configuration, for example, the boundary portion between pieces can be made less noticeable.

In a further modified configuration of the object 40, the manner of building the product 50 and the manner of assembling the object 40 may be modified in various ways. For example, the product 50 for use as a piece that forms the object 40 may be threaded at a portion joined to another piece. In this case, being threaded refers to, for example, forming a groove of a thread. In this case, one of the adjacent products 50 in the object 40 may be a male thread and the other may be the corresponding female thread. With such a configuration, for example, a plurality of products 50 can be connected more firmly. This enables creation of an object 40, for example, with pieces more firmly connected. In this case, the groove of the thread may be formed, for example, directly during building of the product 50. Alternatively, the groove of the thread may be formed in another step after building, rather than forming the groove during building.

In order to connect a plurality of products 50 more firmly, a convex portion may be formed at one of a plurality of products 50 serving as adjacent pieces, and a corresponding concave portion may be formed in the other. Then, the convex portion may be fitted in the concave portion during assembly. In this case, it is preferable that the fitting is done by softening at least one of the convex portion and the concave portion by any means, depending on the properties of the material of the product 50. More specifically, for example, when a material that softens when being soaked in water is used, the product 50 soaked in water and softened may be fitted.

During fitting operation, the effect of expansion or shrinkage with a temperature change may be utilized. In this case, for example, the convex portion may be soaked in cold water and cooled to be shrunken, and thereafter fitted in the concave portion. In this case, the temperature returns to the room temperature after the fitting, enabling the convex portion to be firmly fixed in the concave portion. When the effect of expansion or shrinkage is utilized, for example, the concave portion may be warmed and expanded.

In a modification of the manner of building the product 50, the manner of coloring in the colored region that forms the surface region 202 may be modified in various ways. In such a modification, for example, the resolution of coloring may be changed according to the purpose of the object 40. More specifically, in this case, the resolution of coloring may be changed according to the viewing distance of the object 40 that is determined according to the purpose of the object 40. The viewing distance of the object 40 refers to, for example, the distance to a viewer who views the object 40 during the use of the completed object 40. In this case, for example, the viewing distance is input as a parameter when the conditions for starting the building of the product 50 are set. Then, the resolution may be set depending on the input viewing distance. In this case, when the viewing distance is small, a high resolution is set, whereas when the viewing distance is large, a low resolution is set. With such a configuration, for example, the product 50 can be appropriately colored at a resolution suitable for the purpose of the object 40.

In the foregoing description on a method of dividing the object 40 into a plurality of pieces, a case where the object 40 is divided into a plurality of pieces at the boundary set on the surface of the object 40 has been mainly described. However, in a further modification of the object 40 and the product 50, the object 40 may be divided into a plurality of pieces in various ways, rather than the way as described above. More specifically, in this case, considering the entire structure of a target represented by the object 40, for example, the object 40 may be divided into a plurality of pieces like wood mosaic pieces.

The disclosure can be suitably used, for example, in a method of manufacturing a product.

What is claimed is:

1. A method of manufacturing a product, in which the product is manufactured for use as a piece when an object which is three-dimensional and assembled by combining a plurality of the pieces is created, the method comprising:
building the product by adding a plurality of layers of an ink using an inkjet head configured to eject the ink as a material for building,
the product including
a surface region that partially forms a surface of the object in a state in which the object is assembled,
an end region extending from an edge portion of the surface region to an interior of the object in a state in which the object is assembled, the end region being an end portion on another one of the plurality of the pieces in the interior of the object in a state in which the object is assembled, and
an inside region that is a portion other than the surface region and the end region, the inside region partially forming the interior of the object in a state in which the object is assembled;
forming at least a part of the surface region in a colored state using a coloring ink;
forming at least a part of the inside region as a light-reflective region using a light-reflective ink; and
forming at least a part of a portion along the edge portion of the surface region in the end region, in a colored state using the coloring ink.

2. The method of manufacturing the product according to claim 1, wherein
the surface region includes a colored portion formed using a coloring material so as to conform to a surface shape of the object with a constant thickness, and
in the end region, at least the portion along the edge portion of the surface region with a width larger than the constant thickness of the colored portion in the surface region is formed in a colored state to match the color of the surface region.

3. The method of manufacturing the product according to claim 1, wherein
at least a part of a surface of the end region is orthogonal to the surface region at the edge portion of the surface region,
of a portion orthogonal to the surface region in the surface of the end region, at least the portion along the edge portion of the surface region is formed in a colored state to match the color of the surface region.

4. The method of manufacturing the product according to claim 1, wherein
at least a part of a surface of the end region crosses diagonally to the surface region at the edge portion of the surface region, and
of the surface of the end region, at least the portion along the edge portion of the surface region in a surface facing outside of the object in a state in which the object is assembled is formed in a colored state to match the color of the surface region.

5. The method of manufacturing the product according to claim 1, wherein at least a part of the portion along the edge portion of the surface region in the end region is formed in a colored state to match the color of the surface region, in which coloring is done such that the color in a neighborhood of the edge portion in the surface region extends beyond the edge portion and connects into the end region.

6. The method of manufacturing the product according to claim 1, wherein at least a part of the portion along the edge portion of the surface region in the end region is formed in a colored state to match the color of the surface region, in which coloring is done with same coloration as the color in a neighborhood of the edge portion in the surface region and with a color lighter than the color in the neighborhood.

7. The method of manufacturing the product according to claim 1, wherein the product labeled with an identification information is built, the identification information being for use in identification of the piece forming the object.

8. The method of manufacturing the product according to claim 1, wherein the product having a handling portion is built, the handling portion being a section for use in handling the piece.

9. The method of manufacturing the product according to claim 1, wherein the product having an engagement portion is built, the engagement portion being engaged with another one of the plurality of the pieces in a state in which the object is assembled.

10. The method of manufacturing the product according to claim 1, wherein
the light-reflective ink is a white ink, and
at least a part of the portion along the edge portion of the surface region in the end region is formed such that an outside of a region formed with the white ink is colored.

11. A method of manufacturing an object which is three-dimensional and assembled by combining a plurality of pieces that is divided, wherein
at least one of the plurality of pieces is manufactured by the method of manufacturing the product according to claim 1.

12. A building apparatus configured to build a product for use as a piece when an object which is three-dimensional and assembled by combining a plurality of the pieces is created,
the building apparatus comprising an inkjet head configured to eject an ink as a material of building,
the building apparatus being configured to build the product by adding a plurality of layers of the ink,
the product including
a surface region that partially forms a surface of the object in a state in which the object is assembled,
an end region extending from an edge portion of the surface region to an interior of the object in a state in which the object is assembled, the end region being an end portion on another one of the plurality of the pieces in the interior of the object in a state in which the object is assembled, and
an inside region that is a portion other than the surface region and the end region, the inside region partially forming the interior of the object in a state in which the object is assembled,
at least a part of the surface region being formed in a colored state using a coloring ink,
at least a part of the inside region being formed as a light-reflective region using a light-reflective ink,
at least a part of a portion along the edge portion of the surface region in the end region being formed in a colored state using a coloring ink.
